(19) United States
(12) Patent Application Publication
(10) Pub. No.: US 2012/0148822 A1
(43) Pub. Date: Jun. 14, 2012

(54) CURTAIN FABRIC

(76) Inventor: Shih-Ming LIN, Chiayi Hsien (TW)

(21) Appl. No.: 12/963,670

(22) Filed: Dec. 9, 2010

(51) Int. Cl. B32B 5/02; D03D 13/00; D03D 15/00

(52) U.S. Cl. 428/222; 442/181; 442/187

(57) ABSTRACT

A curtain fabric includes at least one first region including a plurality of non-twisted main fiber bundles extending in a warp direction, and at least one second region including a plurality of first fiber bundles extending in the warp direction and connected respectively to the main fiber bundles, and a plurality of second fiber bundles crossing and interweaving with the first fiber bundles.

### BACKGROUND OF THE INVENTION

1. Field of the Invention

This invention relates to a fabric, and more particularly to a curtain fabric.

2. Description of the Related Art

A conventional curtain fabric is usually made by interweaving weft and warp strands of yarn. Through the various weaving density of the weft and warp strands of the yarn, different light-obscuring effects may be produced. That is, when the weaving density is high, the light-obscuring effect is substantial.

However, because the light-obscuring effect is the same at each portion of the curtain fabric, the visual effect of the conventional curtain fabric lacks variation. Further, the yarn used in weaving the conventional curtain fabric is twisted yarn. When the yarn is interwoven to form the curtain fabric, light can only pass through gaps among the strands of yarn. Since the cross sectional area of the yarn is larger than that of the fiber, the uniformity of light transmission through the gaps among the strands of yarn is poor.

### SUMMARY OF THE INVENTION

Therefore, an object of the present invention is to provide a curtain fabric that has a structural innovation, that has visual effects that can be varied, and that can enhance light transmission quality.

According to this invention, a curtain fabric comprises at least one first region including a plurality of non-twisted main fiber bundles extending in a warp direction, and at least one second region including a plurality of first fiber bundles extending in the warp direction and connected respectively to the main fiber bundles, and a plurality of second fiber bundles crossing and interweaving with the first fiber bundles.

A beneficial effect of this invention resides in the fact that by using the non-twisted fiber bundles to form the first region, the quality of light transmission can be enhanced. Further, through the structural combination of the first and second regions which have different light transmittances, different light penetration and visual effects can be obtained.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic front view of a curtain fabric according to the first preferred embodiment of this invention;

FIG. 2 is a fragmentary enlarged schematic view of the first preferred embodiment;

FIG. 3 is a fragmentary enlarged perspective view of the first preferred embodiment; and

FIG. 4 is a view similar to FIG. 1, but illustrating a curtain fabric according to the second preferred embodiment of this invention.

### DETAILED DESCRIPTION OF THE PREFERRED EMBODIMENTS

Before the present invention is described in greater detail, it should be noted that the same reference numerals have been used to denote like elements throughout the specification.

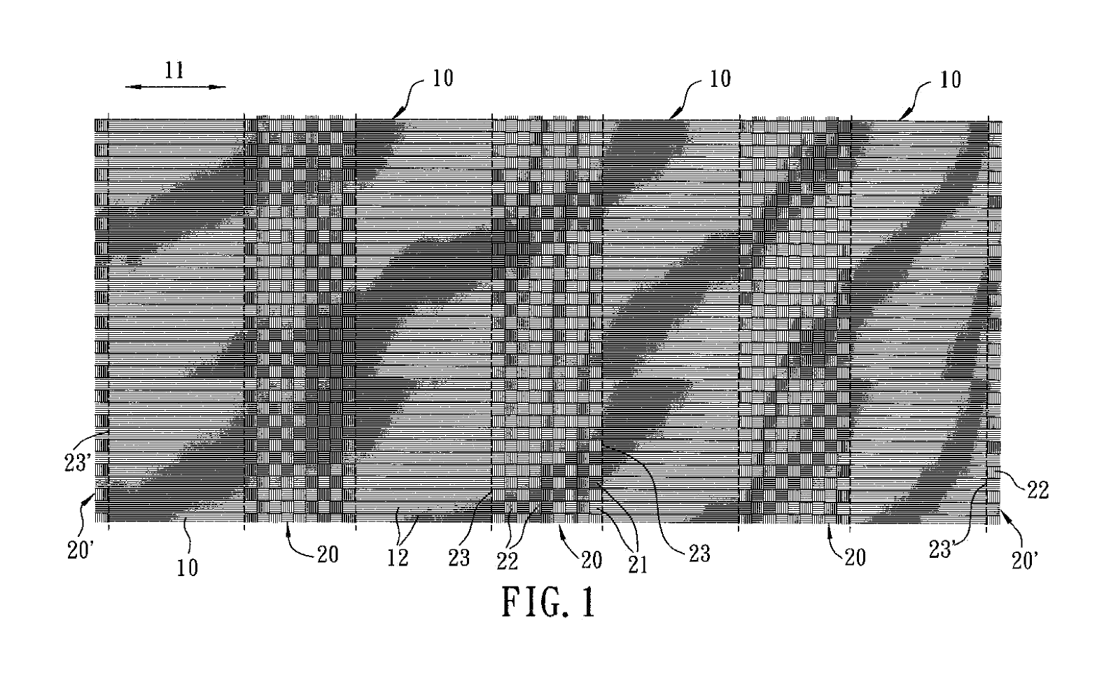

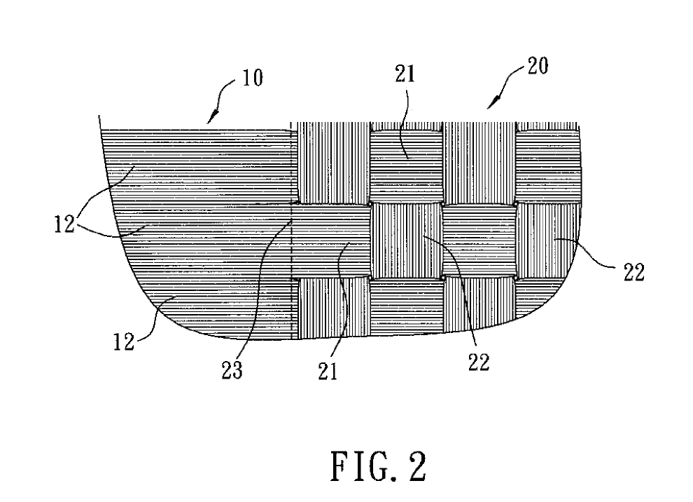

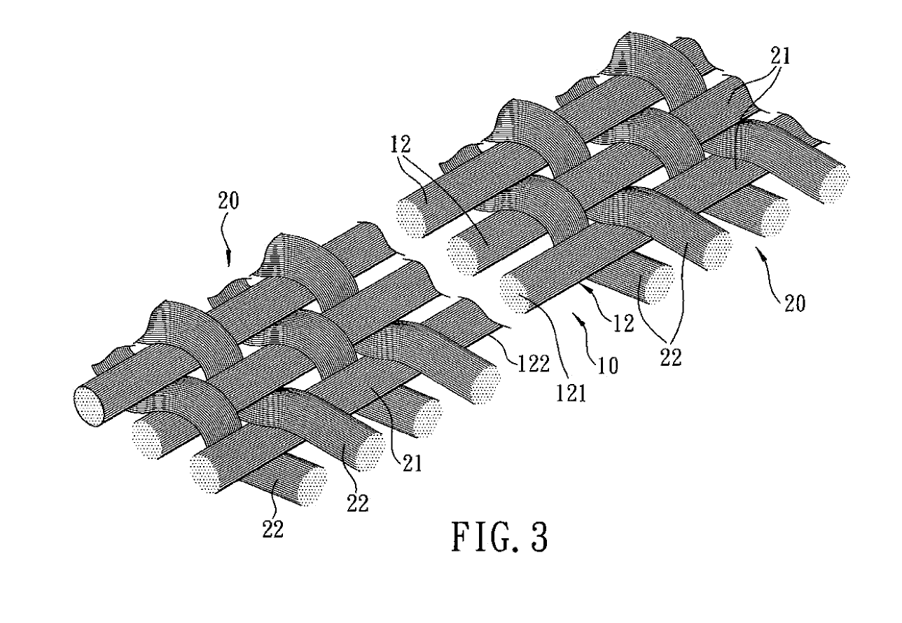

Referring to FIGS. 1 to 3, a curtain fabric according to the first preferred embodiment of this invention is shown to comprise a plurality of first regions 10, a plurality of second regions 20, and two marginal regions 20′.

The first regions 10, in this embodiment, have the same width. Each of the first regions 10 includes a plurality of non-twisted main fiber bundles 12 extending in a warp direction 11. Each of the main fiber bundles 12 has a bundle body 121, and a protective coating 122 covering the bundle body 121. To enhance color variation, the bundle body 121 in this embodiment may be provided with different colors. The protective coating 122 is used to protect the bundle body 121 to thereby increase the rigidity of the main fiber bundle 12.

Each of the second regions 20 has a light transmittance lower than that of the first regions 10. The first and second regions 10, 20 are disposed alternately to each other. Each second region 20 extends in the same direction as the second fiber bundles 22, and includes a plurality of first fiber bundles 21 extending in the warp direction 11 and connected between the main fiber bundles 12 of two adjacent ones of the first regions 10, and a plurality of second fiber bundles 22 crossing and interweaving with the respective first fiber bundles 21. In this embodiment, the first and second fiber bundles are non-twisted fiber bundles, and the structure of each of the first and second fiber bundles 21, 22 is similar to that of the main fiber bundle 12.

A plurality of first reinforcing threads 23 and two second reinforcing threads 23′ are provided on the curtain fabric of the present invention. Each first reinforcing thread 23 is disposed between one of the first regions 10 and one of the second regions 20. Each second reinforcing thread 23′ is disposed between one of the marginal regions 20′ and an adjacent one of the first regions 20. Each of the first and second reinforcing threads 23, 23′ is a twisted yarn having a rigidity, and is interwoven with the first fiber bundles 21.

The marginal regions 20′ extend in the same direction as the second fiber bundles 22. The first and second regions 10, 20 are disposed between the marginal regions 20′. The structure of each marginal region 20′ is similar to that of the second region 20. The marginal region 20′ and the second region 20 differ because each marginal region 20′ has a smaller quantity of the second fiber bundle than the second region 20.

In use, because the main fiber bundles 12 and the first and second fiber bundles 21, 22 are non-twisted fiber bundles, many fine gaps can be formed among these fine fibers so that light can penetrate through uniformly. Further, since each second region 20 is formed by an interweaving process, the light transmittance of each second region 20 is lower than that of the main fiber bundles 12 of each first region 10. The aforesaid novelty structure can permit the curtain fabric to produce different light-penetrating effects and, simultaneously, different visual effects. Hence, the curtain fabric of the first preferred embodiment has light-penetrating fineness and variation of visual effects.

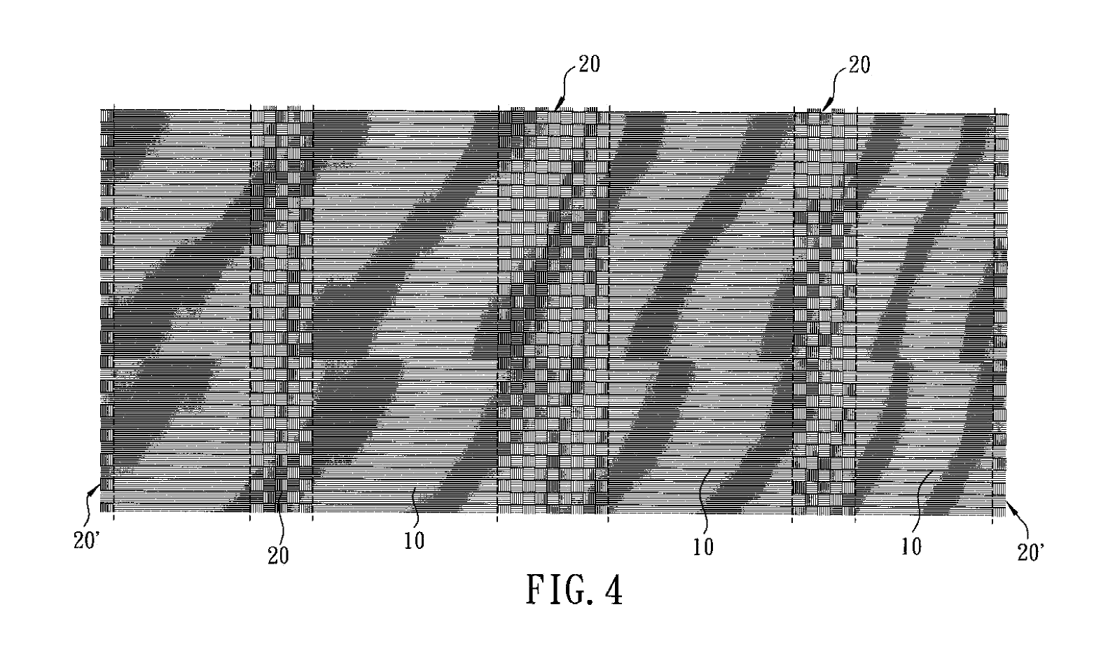

Referring to FIG. 4, a curtain fabric according to the second preferred embodiment of this invention is shown to be similar to the first preferred embodiment. However, in this embodiment, the widths of the first regions 20 are different, so the curtain fabric can display a visual effect different from the first preferred embodiment. Alternatively, each second region 20 may have an inclined configuration or be formed with different patterns. As such, the variation of visual effects of the present invention may be enhanced.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A curtain fabric, comprising:
at least one first region including a plurality of non-twisted main fiber bundles extending in a warp direction; and
at least one second region including a plurality of first fiber bundles extending in said warp direction and connected respectively to said main fiber bundles, and a plurality of second fiber bundles crossing and interweaving with said first fiber bundles.

2. The curtain fabric of claim 1, wherein each of said main fiber bundles has a bundle body, and a protective coating covering said bundle body.

3. The curtain fabric of claim 2, wherein said first and second fiber bundles are non-twisted fiber bundles.

4. curtain fabric of claim 2, further comprising at least one reinforcing thread disposed between said first and second regions and extending in a same direction as that of said second fiber bundles, said reinforcing thread being a twisted yarn.

5. The curtain fabric of claim 1, further comprising two marginal regions extending in a same direction as that of said second fiber bundles, a plurality of said first and second regions being disposed alternately to each other between said marginal regions.

6. The curtain fabric of claim 5, wherein each of said main fiber bundles has a bundle body, and a protective coating covering said bundle body, said first and second fiber bundles being non-twisted fiber bundles.

7. The curtain fabric of claim 6, further comprising a plurality of first reinforcing threads each of which is disposed between one of said first regions and one of said second regions, and two second reinforcing threads each of which is disposed between one of said marginal regions and an adjacent one of said first regions, each of said first and second reinforcing threads extending in the same direction as that of said second fiber bundles, and being a twisted yarn.
